(19) United States
(12) Patent Application Publication
(10) Pub. No.: US 2018/0035769 A1
(43) Pub. Date: Feb. 8, 2018

(54) POUCH SYSTEM AND METHODS OF USE THEREOF

(71) Applicant: Lawnae Elizabeth Wilber, Bend, OR (US)

(72) Inventor: Lawnae Elizabeth Wilber, Bend, OR (US)

(21) Appl. No.: 15/668,381

(22) Filed: Aug. 3, 2017

Related U.S. Application Data
(60) Provisional application No. 62/371,618, filed on Aug. 5, 2016.

(51) Int. Cl. A45B 3/10; A61H 3/00

(52) U.S. Cl. CPC A45B 3/10; A61H 3/00; A45C 3/00

(57) ABSTRACT

Disclosed herein is a system for storing, transporting and containing items while operating or using any device, such as a cane, crutch, walker, stroller, bike, scooter, boat, pole, backpack or wheelchair. In one example, a disclosed system includes a pouch with a first vertical attachment member formed of hook and loop material and a second vertical attachment member having an adhesive back and a hoop and loop material front. In some examples, the pouch has horizontal attachment members which allow additional attachment points for the pouch to be secured to the device. In use, the second vertical attachment member is secured to the device by the adhesive backing and the pouch is coupled to the device by aligning and pressing the hook and loop material surface of the first vertical attachment member on the pouch with the hook and loop material of the second vertical attachment on the device.

### CROSS REFERENCE TO RELATED APPLICATION

This disclosure claims the benefit under 35 U.S.C. 119(e) of U.S. Provisional Application No. 62/371,618 filed on Aug. 5, 2016, which is hereby incorporated by reference in its entirety.

### FIELD

This disclosure relates to a system for storing, transporting and containing items such as when using an ambulatory device (e.g., a cane, crutch, walker or wheelchair) or other modes of transportation, such as a stroller, bike, scooter or boat or items, such as a backpack, pole or line.

### BACKGROUND

Often a user of an ambulatory device, such as a cane, walker or wheelchair, needs to be able to transport personal items while using such device. Use of a traditional purse or backpack often interferes with the user's ability to operate the ambulatory device as it may put the user off balance. Further, attempting to attach a traditional purse or backpack to an ambulatory device can lead to the purse or backpack falling off or becoming entangled with the device. Therefore, a need exists for a system that allows a user to transport personal items easily and effectively while using an ambulatory device. Additionally, the need exists to be able to transport or secure personal items without interfering with the operation of a device or to allow ones personal belonging to be securely stowed.

### SUMMARY

Disclosed herein is a system for storing, transporting and containing items while operating any device, such as an ambulatory device (e.g., a cane, crutch, walker or wheelchair) or other mode of transportation, such as a stroller, bike, scooter or boat or article, such as a pole, line or backpack. In one embodiment, a disclosed system comprises a pouch with a first vertical attachment member for securing the pouch to the device, article or surface and a second vertical attachment member which facilitates the fastening of the pouch to the device, article or surface by coupling to the first vertical attachment member on the pouch. In some embodiments, a disclosed pouch further comprises one or more horizontal attachment members to provide additional points of attachment between the device, article or surface and the pouch. In some embodiments, the first vertical attachment member comprises hook and loop fastening material on a first, front side and a second, back side capable of being attached to the pouch. In some embodiments, the second vertical attachment member comprises hook and loop fastening material on a first, front side and adhesive material on a second, back side so that the adhesive side may be secured to the device, article or surface in a position desired by the user to secure the pouch. The hook and loop fastening material on the front side of the second vertical attachment member can interconnect with the hook and loop fastening material on the first vertical attachment member on the pouch thereby securing the pouch to the device, article or surface. It is contemplated that the disclosed system can be used with any device, such as an ambulatory device, transportation device or other item including, but not limited to, a cane, crutch, walker, stroller, bike, scooter, boat, wheelchair, pole, line or backpack.

Also disclosed are methods of assembling a pouch system. In some embodiments, the method comprises positioning the second vertical attachment member on a surface, such as an ambulatory or transportation device surface, in a location to which the user wishes to secure the pouch; aligning the first, front surface of hook and loop fastening material of the first vertical attachment member with the first, front surface of hook and loop fastening material of the second vertical attachment member so that that two can interconnect and thereby attaching the pouch to the desired surface. In some embodiments, the method further comprises attaching one or more horizontal attachment members to the surface, such as an ambulatory or transportation device surface, to further secure the pouch to the desired surface.

The foregoing and other features of the disclosure will become more apparent from the following detailed description, which proceeds with reference to the accompanying figures.

### BRIEF DESCRIPTION OF THE DRAWINGS

FIG. 1 is a perspective view an exemplary pouch system.

FIG. 2 is a rear view of an exemplary pouch.

FIG. 3 is a front view of an exemplary second vertical attachment member coupled to an ambulatory device.

FIG. 4 is a rear view of an exemplary pouch with a plurality of fasteners secured to an ambulatory device.

### DETAILED DESCRIPTION

In the following detailed description, reference is made to the accompanying drawings which form a part hereof, and in which are shown by way of illustration embodiments that may be practiced. It is to be understood that other aspects and/or embodiments may be utilized and structural or logical changes may be made without departing from the scope. Therefore, the following detailed description is not to be taken in a limiting sense, and the scope is defined by the appended claims and their equivalents.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and method.

Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. Similarly, the word “or” is intended to include “and” unless the context clearly indicates otherwise. Hence “comprising A or B” means including A, or B, or A and B.

Although methods and materials similar or equivalent to those described herein can be used in the practice or testing of the present disclosure, suitable methods and materials are described below.

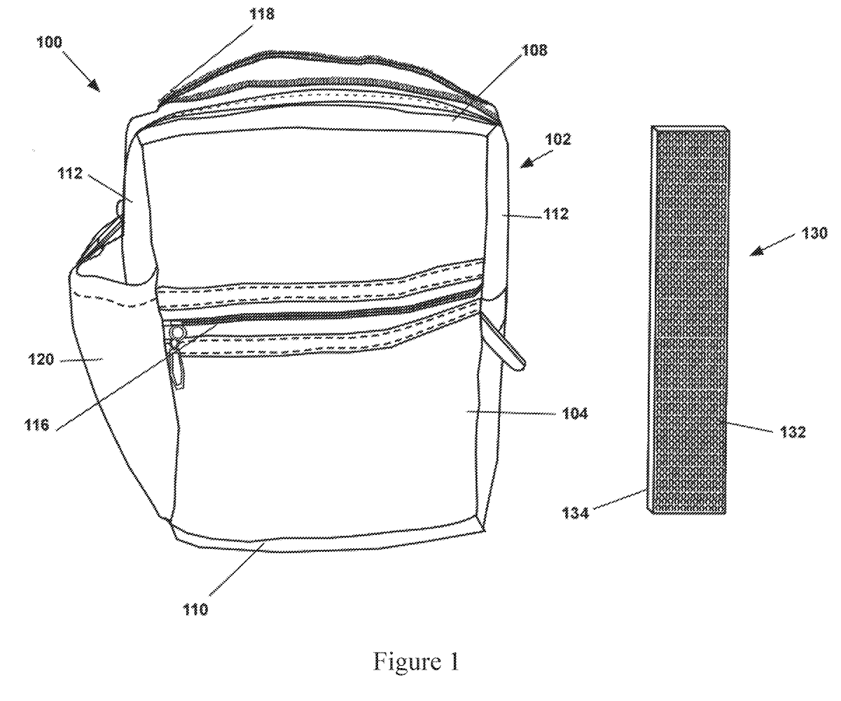

Referring to the drawings, FIG. 1 shows an embodiment of disclosed system 100. It is contemplated that the disclosed system can be used with any device or surface including, but not limited to, a cane, crutch, walker, wheelchair, stroller, bike, scooter, boat, pole, line or backpack. In some embodiments, the device is an ambulatory device, such as a cane, crutch, walker or wheelchair. In some embodiments, the device is a transportation device such as a bike, scooter or boat. As illustrated, the system 100 includes pouch 102. Pouch 102 is an outer shell to define an interior space in which items can be stored, transported or contained. In some embodiments, the outer shell has front panel 104, rear panel 106. top panel 108, bottom panel 110 and two side panels 112. in some examples, the outer shell comprises at least one compartment, such as front panel compartment 114. in sonic examples, front panel compartment 104 includes fastening mechanism 116. For example, fastening mechanism 116 can be a zipper, eyes and hooks, hook and loop fastening material, snaps or any other fastener which allows the compartment to be opened and dosed. In some examples, top panel 103 includes fastening mechanism 118 which allows a user to access the interior space of the pouch and to secure the interior space. For example, fastening mechanism 118 can be a zipper, eyes and hooks, hook and loop fastening material, snaps or the like. In some examples, at least one of the two side panels includes a side compartment, such as elongated compartment 120. It is contemplated that the side compartment can further comprises a fastening mechanism. In one specific example, the side compartment is shaped to hold an elongated bottle, such as a water bottle. In some examples, pouch 102 does not include a strap.

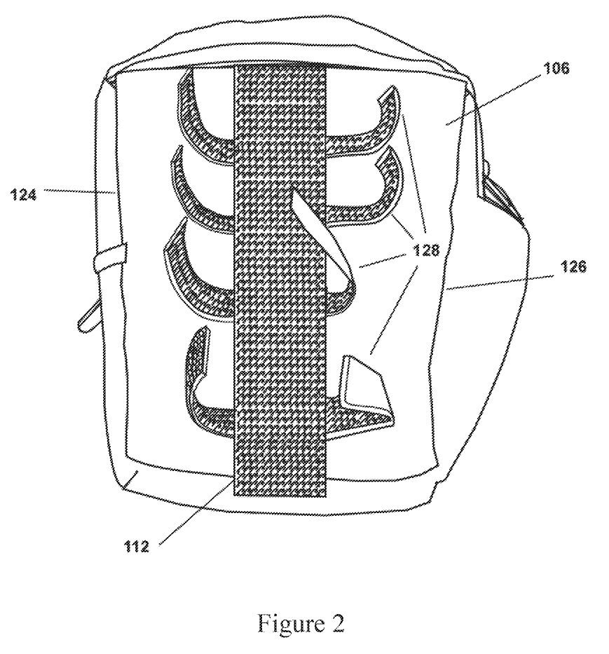

FIG. 2 illustrates rear panel 106 of pouch 102. As illustrated, rear panel 106 includes a. first vertical attachment member 122. in some examples, first vertical attachment member 112 is sewn or otherwise affixed to rear panel 1106. In one example, first vertical attachment member 112 is sewn to rear panel 106 so that it is equal distance from a first vertical edge 124 of rear panel 106 and a second vertical edge 126. In some examples, first vertical attachment member 112 comprises a first, front side and a second, back side capable of being attached to the pouch. For example, a first, front side may be formed or including a fastening mechanism to facilitate the attachment of the pouch to a device and a second, back side formed of a material capable of being attached, such as sewn, to the pouch. In one example, the first, front side is hook and loop fastening material. In some examples, the first vertical attachment member is between 2 inches and 4 inches wide (such as 2 inches, 2½ inches, 3 inches, 3½ inches, or 4 inches) and extends the length of the rear panel. In some examples, the vertical attachment member extends at least 70% the length of the rear panel, such as at least 75%, 80%, 85%, 90%, 95% or 100%, including between 80% and 100%, 90% and 100% of the length of the rear panel.

In some examples, pouch 102 further comprises one or more horizontal attachment members 128 coupled to the pouch to provide additional points of attachment between the device or item and the pouch. In some examples, one or more horizontal attachment members 128 are a plurality of attachment members. In some examples, the one or more horizontal attachment members are coupled to the first vertical attachment member. For example, the one or more horizontal attachment members are positioned and secured to the pouch behind the first vertical attachment member. For instance, the one or more horizontal attachment members are designed to loop around a surface, such as an ambulatory device, for example, a cane, for added security once the first vertical attachment member is secured to the device. In some examples, the one or more horizontal attachment members are formed of hook and loop fastening material. In some examples, the pouch comprises an even number of horizontal attachment members, such as 2, 4, or 6 horizontal attachment members. In other examples, the pouch comprises an odd number of horizontal attachment members, such as 1, 3, or 5 horizontal attachment members. In some examples, the one or more horizontal attachment members are spaced equidistant along the first vertical attachment member. In some examples, the one or more horizontal attachment members are spaced asymmetically along the first vertical attachment member. It is contemplated that the shape of the one or more horizontal attachment members may vary depending upon the device. In some examples, the one or more horizontal attachment members range in length of 1 to 4 times the diameter of the device to which they will be attached. In some examples, the one or more horizontal attachment members are strips of hook and loop fastening material ranging in length from 6 inches to 12 inches, including 6 inches, 6½ inches, 7 inches, 7½ inches, 8 inches, 8½ inches, 9 inches, 9½ inches, 10 inches, 10½ inches, 11 inches, 11½ inches, 12 inches, and width from ½ to 3 inches, such as 1 inch to 2 inches, including 1 inch, 1¼ inches, 1½ inches, 1¾ inches, 2 inches, 2¼ inches, 2½ inches, 2¾ inches and 3 inches.

Pouch 102 is an outer shell which can be formed of a pliable material such as cloth, leather, vinyl, suede or the like. In some examples, the outer shell comprises a durable, flexible textile material, such as a woven fabric. In some examples, the outer shell comprises a fabric mesh allowing a user to easily see the contents in the interior space. In some examples, the rear panel is formed of a fabric of greater rigidity than the remainder of outer shell. In some examples, at least one compartment is formed of a solid fabric. In one particular example, the rear panel is formed of polyester fabric, at least one compartment is formed of polyester fabric and the remainder of the pouch is formed of mesh material.

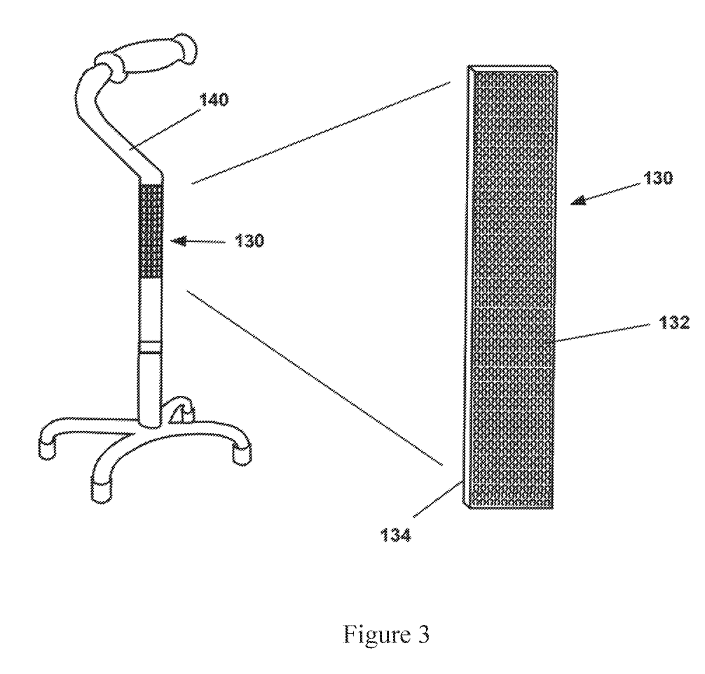

Also as shown in FIG. 1, system 100 includes a second vertical attachment member 130. Second vertical attachment member 130 is configured to facilitate attachment of pouch 102 to a surface, such as an ambulatory device (as shown in FIG. 3), transportation device/system or any other desired surface. In some examples, second vertical attachment member 130 has a first, front side 132 with a fastening mechanism, such as hook and loop fastening material, for operationally coupling a pouch to a surface, such as an ambulatory or transportation device surface, and a second, back side 134 with a fastening mechanism, such as an adhesive, for attaching the second vertical attachment member to the device surface. In one example, second vertical attachment member 130 includes hook and loop fastening material on a first, front side and adhesive material on a second, back side so that the adhesive backing may be secured to the surface in a position desired by the user to secure the pouch and the hook and loop fastening material on the first, front side can interconnect with the first, front side of hook and loop fastening material of the first vertical attachment member thereby allowing the pouch to be secured to the desired surface. It is contemplated that the size and shape of a second vertical attachment member can vary, for example dependent upon the surface, e.g., ambulatory or transportation device and/or the pouch. In some examples, the second vertical attachment member is similar in dimension to the first vertical attachment member. For example, the length and/or width of the second vertical attachment member is at least 50% the length and/or width of the first vertical attachment member, including between 50% and 150%, between 75% and 95%, between 80% and 90%, between 90% and 100%, between 90% and 110% such as 50%, 55%, 60%, 65%, 70%, 75%, 80%, 85%, 90%, 95%, 100%, 105%, 110%, 115%, 120%, 125%, 130%, 135%, 140%, 145% or 150% the length and/or width of the first vertical attachment member. In some examples, more than one second vertical attachment member can be used to attach the pouch to the surface of the device, system or item. For example, two second vertical attachment members that as a sum approximately equal the length of the first vertical attachment member can be utilized to secure the pouch. In some examples, a second vertical attachment member is ½ to 3 inches in width, such as 1 inch to 2 inches, including 1 inch, 1¼ inches, 1½ inches, 1¾ inches, 2 inches, 2¼ inches, 2½ inches, 2¾ inches and 3 inches and 6 inches to 12 inches in length, such as 9 inches to 12 inches, including 6 inches, 6½ inches, 7 inches, 7½ inches, 8 inches, 8½ inches, 9 inches, 9½ inches, 10 inches, 10½ inches, 11 inches, 11½ inches, and 12 inches.

It is contemplated that the direction of the first and/or second attachment members may be altered depending upon the surface to which the pouch is to be attached. In additional embodiments, a pouch system is disclosed which includes a rear panel with a first horizontal attachment member instead of a first vertical attachment member. In such embodiment, the second attachment member is positioned horizontally along a horizontally surface of the surface (such as a walker). In some embodiments, the secondary attachment member is positioned alone a horizontal surface on a device and is coupled to the first vertical attachment member on the rear panel of the pouch. In some other embodiments, a pouch system includes a rear panel with both a first horizontal attachment member and a first vertical attachment member. The second attachment member in this embodiment may then be placed along either the horizontal or vertical surface of the device, system or item.

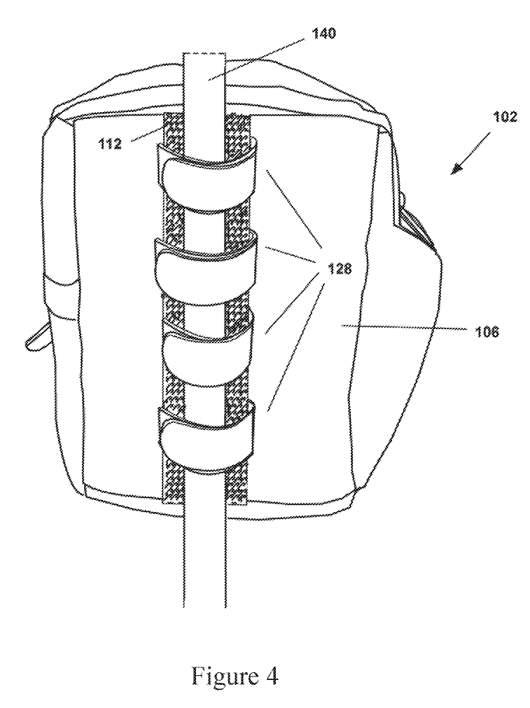

Also disclosed are methods of assembling a pouch system. In some embodiments, the method comprises positioning the second vertical attachment member on a surface in a location to which the user wishes to secure the pouch; aligning the first, front surface of hook and loop fastening material of the first vertical attachment member with the first, front surface of hook and loop fastening material of the second vertical attachment member so that that two can interconnect and thereby attaching the pouch to the surface, such as an ambulatory device or transportation device/system. In some embodiments, the method further comprises attaching one or more horizontal attachment members to the device, system or item to further secure the pouch. FIG. 4 illustrates an exemplary pouch secured to an ambulatory device.

In view of the many possible embodiments to which the principles of the disclosure may be applied, it should be recognized that the illustrated embodiments are only preferred examples and should not be taken as limiting the scope of the invention. Rather, the scope of the invention is defined by the following claims. I therefore claim as my invention all that comes within the scope and spirit of these claims.

I claim:

1. A system, comprising:
a pouch with a first vertical attachment member for securing the pouch to a device; and a second vertical attachment member which facilitates the fastening of the pouch to the device by coupling to the first vertical attachment member on the pouch.

2. The system of claim 1, wherein the pouch further comprises one or more horizontal attachment members coupled to the pouch to provide additional points of attachment between the device and the pouch.

3. The system of claim 2, wherein the one or more horizontal attachment members are a plurality of attachment members.

4. The system of claim 3, wherein the one or more horizontal attachment members are coupled to the first vertical attachment member.

5. The system of claim 4, wherein the first vertical attachment member comprises hook and loop fastening material on a first, front side and a second, back side capable of being attached to the pouch.

6. The system of claim 5, wherein the second vertical attachment member comprises hook and loop fastening material on a first, front side and adhesive material on a second, back side so that the adhesive side may be secured to the device in a position desired by the user to secure the pouch.

7. The system of claim 6, wherein the pouch comprises an outer shell structured to define an interior space.

8. The system of claim 7, wherein the outer shell has a front panel, a rear panel, a top panel, a bottom panel and two side panels.

9. The system of claim 8, wherein the first vertical attachment member for securing the pouch to the device is coupled to the rear panel.

10. The system of any one of claim 9, wherein the outer shell comprises at least one compartment.

11. The system of claim 10, wherein the front panel comprises a front panel compartment.

12. The system of claim 11, wherein the front panel compartment comprises a fastening device to allow the compartment to be closed.

13. The system of claim 12, wherein the fastening device is a zipper.

14. The system of claim 10, wherein the top panel comprises a fastening device to allow the compartment to be closed.

15. The system of claim 14, wherein the fastening device is a zipper.

16. The system of claim 15, wherein at least one of the two side panels comprises a side compartment.

17. The system of claim 16, wherein the side compartment is an elongated compartment.

18. The system of claim 17, wherein the outer shell comprises a flexible fabric.

19. A method of assembling the pouch system of claim 1, comprising:
positioning the second vertical attachment member on a device surface;
aligning the first vertical attachment member on the pouch with the second vertical attachment member on the device so that the first vertical attachment member interconnects with the second vertical attachment member and thereby attaching the pouch to a device.

20. The method of claim 19, further comprising attaching one or more horizontal attachment members attached to the pouch to the device to further secure the pouch to the device.
